(19) United States
(12) Patent Application Publication
(10) Pub. No.: US 2025/0313286 A1
(43) Pub. Date: Oct. 9, 2025

(54) GOOSENECK COUPLER LOCK

(71) Applicant: DYNAMIC MANUFACTURING GROUP LLC, PALMETTO, FL (US)

(72) Inventors: Ronald Lee, JR., Ruskin, FL (US); Anthony Sansone, Parrish, FL (US)

(21) Appl. No.: 18/628,903

(22) Filed: Apr. 8, 2024

(51) Int. Cl. B62D 53/10

(52) U.S. Cl. CPC B62D 53/10

(57) ABSTRACT

A trailer coupler (e.g., gooseneck coupler) lock assembly includes a lock housing (housing), a retainer plate (retainer) and a coupler head case (case). The retainer and case each include a tab with a hole that extends through a window in the lock housing and is engaged by a shackle of a hidden shackle padlock, which locks the retainer and case to the housing. The housing and the case define a volume for receiving a gooseneck coupler head, with upper panels of the case and housing protecting and impeding removal of the gooseneck coupler head. A ball profile extends from a base of the case into a socket of the head of the coupler. The retainer and/or one or more notches in the lock housing secure a latching mechanism of the gooseneck coupler in a locked position, preventing disengagement of the ball profile.

### FIELD OF THE INVENTION

This invention relates generally to gooseneck couplers for trailers, and, more particularly, to a lock that secures the latch and protects the socket and head of a trailer coupler such as a gooseneck coupler.

### BACKGROUND OF THE INVENTION

Trailers equipped with couplers, such as gooseneck couplers, are vulnerable to theft when unattended. To deter theft, various gooseneck coupler locks have been devised. Some locks may contain a ball or ball profile that enters the socket of a gooseneck coupler. A locking mechanism secures the ball or ball profile in the socket. Other locks secure the latch mechanism of the coupler in a locked position. Many use ordinary padlocks to secure the latch. Prior art locks are configured for only one type of coupler. A different lock is required for each different coupler.

While prior art locks provide a measure of security, they are vulnerable to ordinary bolt cutters. Concomitantly, prior art locks leave exposed substantial portions of the top surface of the coupler head (i.e., the portion of the coupler that includes the socket in which a ball is received). The exposure renders the head vulnerable to damage and compromise by a motivated thief. Additionally, prior art locks are not configurable to work with various couplers. Furthermore, prior art couplers are vulnerable to lateral forces, because the ball profile is often a sheet metal structure that lies in a sagittal plane and the underjaw of a latching mechanism abuts only a thin edge of the structure.

A gooseneck coupler that avoids these shortcomings is needed. The coupler should avoid use of padlocks that are vulnerable to ordinary bolt cutters. The coupler should substantially cover the gooseneck coupler head. The coupler should be adaptable for use with various types of gooseneck couplers and latches. The coupler should positively engage a socket of a gooseneck coupler head. The coupler should protect against lateral forces.

The invention is directed to overcoming one or more of the problems and solving one or more of the needs as set forth above.

### SUMMARY OF THE INVENTION

To solve one or more of the problems set forth above, in an exemplary implementation of the invention, a gooseneck coupler lock assembly is provided. The exemplary gooseneck coupler lock assembly includes a lock housing (housing), a retainer plate (retainer), a coupler head case (case) and a ball profile. The retainer and case each include a tab with a hole that extends through a window in the lock housing and is engaged by a shackle of a hidden shackle padlock, which locks the retainer and case to the housing. The housing and the case define a volume for receiving a gooseneck coupler head, with upper panels of the case and housing protecting and impeding removal of the gooseneck coupler head.

The ball profile extends from a base of the case into a socket of the head of the coupler. The latching mechanism of the gooseneck coupler is moved into a locked position after the ball profile is inserted into the socket. The retainer and/or one or more notches in the lock housing secure a latching mechanism of the gooseneck coupler in a locked position, preventing removal of the ball profile.

The housing receives a hidden shackle padlock (aka, “puck lock”). The retainer and the case each include a staple (a tab with a hole) that extends through a window in the housing. A shackle of the puck lock extends through the aligned staples to lock the retainer and case to the housing. The retainer slides into a slot in the housing. Being wider than the housing, portions of the retainer extend from the slot. Such portions are engaged by slots in the case. The retainer includes a slot or concave cutout for engaging a coupler latch in a locked position. Optionally, a ball profile extends from the base of the case. The ball profile is received in a socket of a head of the coupler. Sidewalls and upper walls of the case and housing protect an enclosed coupler head.

A retainer slides into a slot in the housing. The retainer may include a central slot or a broad concave groove for retaining a latch (lever or handle) of a gooseneck coupler in a locked position and/or for locating the retainer at a position relative to the gooseneck coupler that enables assembly of the gooseneck coupler lock assembly. The retainer may be a removable component. A retainer configured to work with a specific latch may be selected for a particular gooseneck coupler.

The housing includes a tubular flange for receiving a hidden shackle lock. Hasps or staples (tabs) of the case and plate extend through a window of the housing and align in the tubular flange for locking. When locked, a shackle of a hidden shackle lock extends through aligned holes in the tabs of the case and plate. When the latch of the gooseneck coupler is in a locked position and the assembly is locked with a hidden shackle lock, the plate and case are secured to the housing, the case is secured to the head of the gooseneck coupler, and the latch of the gooseneck coupler is secured in the notch of the retainer in a locked position.

Optionally, the housing may include one or a pair of notches in sidewalls. A notch is positioned, shaped and sized to receive a portion of a handle of a latching mechanism of a gooseneck coupler, when the latching mechanism, is in a locked position.

The housing receives a hidden shackle padlock (aka, “puck lock”). The retainer and the case each include a staple (a tab with a hole) that extends through a window in the housing. A shackle of the puck lock extends through the aligned staples to lock the retainer and case to the housing. The retainer slides into a slot in the housing. Being wider than the housing, portions of the retainer extend from the slot. Such portions are engaged by slots in the case. The retainer includes a slot or concave cutout for engaging a coupler latch in a locked position. Optionally, a ball profile extends from the base of the case. The ball profile is received in a socket of a head of the coupler. Sidewalls and upper walls of the case and housing protect an enclosed coupler head.

A retainer slides into a slot in the housing. The retainer may include a central slot or a broad concave groove for retaining a latch (lever or handle) of a gooseneck coupler in a locked position and/or for locating the retainer at a position relative to the gooseneck coupler that enables assembly of the gooseneck coupler lock assembly. The retainer may be a removable component. A retainer configured to work with a specific latch may be selected for a particular gooseneck coupler.

The housing includes a tubular flange for receiving a hidden shackle lock. Hasps or staples (tabs) of the case and plate extend through a window of the housing and align in the tubular flange for locking. When locked, a shackle of a hidden shackle lock extends through aligned holes in the tabs of the case and plate. When the latch of the gooseneck coupler is in a locked position and the assembly is locked with a hidden shackle lock, the plate and case are secured to the housing, the case is secured to the head of the gooseneck coupler, and the latch of the gooseneck coupler is secured in the notch of the retainer in a locked position.

Optionally, the housing may include one or a pair of notches in sidewalls. A notch is positioned, shaped and sized to receive a portion of a handle of a latching mechanism of a gooseneck coupler, when the latching mechanism, is in a locked position.

The housing and the case define a volume for receiving a gooseneck coupler head, with upper panels of the case and housing protecting and impeding removal of the gooseneck coupler head and also resisting longitudinal and lateral forces against the housing. Such resistance protects the ball profile contained in the socket of the coupler from disengaging or structurally failing.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of a gooseneck coupler equipped with an exemplary gooseneck coupler lock assembly according to principles of the invention;

FIG. 2 is bottom perspective view of a gooseneck coupler without with a lock assembly according to principles of the invention;

FIG. 3 is first perspective view of an exemplary gooseneck coupler lock assembly according to principles of the invention;

FIG. 4 is second perspective view of an exemplary gooseneck coupler lock assembly according to principles of the invention;

FIG. 5 is a first exploded perspective view of an exemplary gooseneck coupler lock assembly according to principles of the invention;

FIG. 6 is a second exploded perspective view of an exemplary gooseneck coupler lock assembly according to principles of the invention;

FIG. 7 is a perspective view of an exemplary lock housing for an exemplary gooseneck coupler lock assembly according to principles of the invention;

FIG. 8 is a front view of an exemplary lock housing for an exemplary gooseneck coupler lock assembly according to principles of the invention;

FIG. 9 is a plan view of an exemplary retainer plate for an exemplary gooseneck coupler lock assembly according to principles of the invention;

FIG. 10 is a perspective section view of an exemplary coupler head case for an exemplary gooseneck coupler lock assembly according to principles of the invention;

FIG. 11 is a perspective view of another gooseneck coupler equipped with an exemplary gooseneck coupler lock assembly according to principles of the invention;

FIG. 12 is an exploded perspective view of the gooseneck coupler of FIG. 10 and an exemplary gooseneck coupler lock assembly according to principles of the invention;

FIG. 13 is a perspective view of an exemplary lock housing and retainer plate assembly for an exemplary gooseneck coupler lock assembly according to principles of the invention;

FIG. 14 is a perspective view of an exemplary ball profile for an exemplary gooseneck coupler lock assembly according to principles of the invention;

FIG. 15 is an exploded perspective view of an exemplary ball profile for an exemplary gooseneck coupler lock assembly according to principles of the invention;

FIG. 16 is a side view of an exemplary ball profile engaged by an underjaw of an exemplary gooseneck coupler according to principles of the invention;

FIG. 17 is a perspective view of an alternative ball profile for an exemplary gooseneck coupler lock assembly according to principles of the invention; and

FIG. 18 is a perspective view of another alternative ball profile for an exemplary gooseneck coupler lock assembly according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

A gooseneck coupler lock assembly according to principles of the invention includes a casing assembly (i.e., enclosure) comprised of a coupler head case, a lock housing, and a retainer plate. The coupler head case receives the head of a gooseneck coupler. The head is the portion of the coupler that includes a socket, into which a ball attached to a truck bed is received. The head is joined by welding to a tube (i.e., the tubular neck—gooseneck) of the gooseneck coupler. The sides and back of the case extend above the weld. More specifically, the case includes a base and back and side walls (or panels), each extending upward from the base and each having a top. Upper panels extend from the tops of the walls and overhang the base. Similarly, the lock housing, which mates with the front of the case, includes a front wall having a top, and an upper panel that extends from the top of the front wall. Together, the lock housing and the case define a volume for receiving a gooseneck coupler head. Additionally, the upper panels of the case and lock housing impede removal of the gooseneck coupler lock assembly when the lock housing is mated with the case. The upper panels are flanges that extend from walls to prevent removal of the lock assembly and protect the joint (i.e., the joint between the tube and head of the gooseneck coupler) from tampering.

The case may contain an interlocking ball profile, i.e., a protrusion from a base of the case that is sized and shaped to fit within the socket of the gooseneck coupler and is retained (i.e., locked) in the socket when the latch of the gooseneck coupler is locked. The ball profile may be removable or fixed to the base of the case. A wide variety of ball profile structures may be used without departing from the scope of the invention.

The retainer plate slides into a slot in the lock housing. The retainer plate includes a central groove for retaining a latch (lever or handle) of a gooseneck coupler in a locked position and/or for locating the retainer at a position relative to the gooseneck coupler that enables assembly of the gooseneck coupler lock assembly. The retainer plate may be a removable component. A retainer plate configured to work with a specific latch may be selected for a particular gooseneck coupler.

The lock housing mates with the case at the front end of the case. The lock housing includes a tubular flange for receiving a hidden shackle lock. Hasps or staples of the case and plate extend through a window of the housing and align in the tubular flange for locking. When locked, a shackle of a hidden shackle lock extends through aligned holes in the hasps or staples of the case and plate. When the latch of the gooseneck coupler is in a locked position and the assembly is locked with a hidden shackle lock, the plate and case are secured to the housing, the case is secured to the head of the gooseneck coupler, and the latch of the gooseneck coupler is secured in the notch of the retainer plate in a locked position.

A lock assembly according to principles of the invention reduces risk of theft by substantially encasing the head of a gooseneck coupler. The encased head cannot be coupled to a towing ball. Additionally, a retainer plate (retainer) of the lock assembly may be selected to work with a particular latch of a gooseneck coupler. Thus, the lock assembly may be configured to work with a wide range of gooseneck couplers.

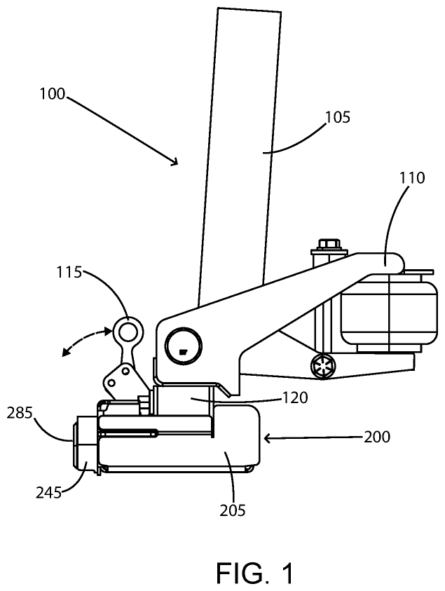

FIG. 1 is a side view of a gooseneck coupler 100 equipped with an exemplary gooseneck coupler lock assembly 200 according to principles of the invention. The gooseneck coupler 100 includes a tubular neck 105 to which a head 120 is attached. The head 120 includes a socket for mating engagement with a tow ball. A case 205 of the lock assembly 200 contains a substantial portion of the head 120. The gooseneck coupler 100 includes a lever 115. The lever 115, part of a latching mechanism, is movable from an unlocked position to a locked position. When the lever 115 is in the locked position, the latching mechanism prevents removal of a tow ball from the socket. When the lever 115 is in the opened (unlocked) position, the latching mechanism does not prevent removal of a tow ball from the socket. A lock housing mates with the case at the front end of the case. The lock housing includes a tubular flange 245 for receiving a hidden shackle lock 285.

The gooseneck coupler 100 of FIG. 1 includes an air bag suspension system 110. The invention is not limited to use with a gooseneck coupler having a suspension system, or any particular type of suspension system. The invention may be used with gooseneck couplers that have or lack a suspension system.

The gooseneck coupler 100 of FIG. 1 includes a lever 115 that pivots about an axis that is perpendicular to the longitudinal axis of the gooseneck. The invention is not limited to use with a gooseneck coupler having such a lever. The invention may be used with gooseneck couplers that have a different lever, including a lever that pivots about an axis that is parallel to the longitudinal axis of the gooseneck.

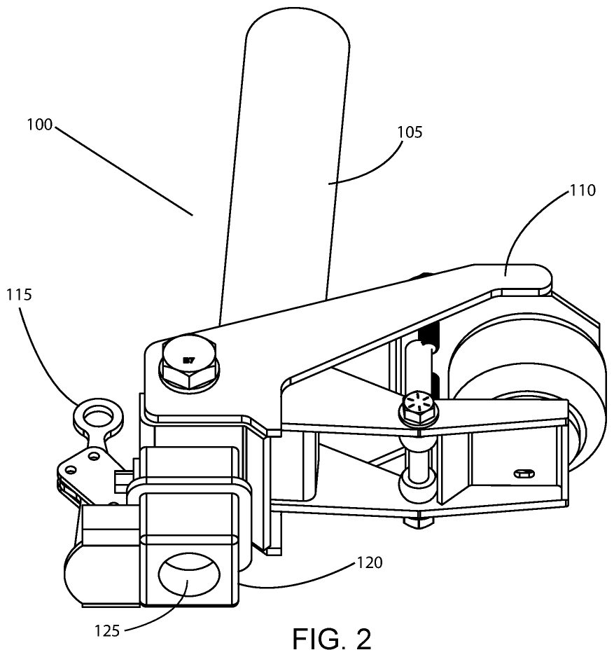

FIG. 2 provides a bottom perspective view of a gooseneck coupler without with a lock assembly according to principles of the invention. In this view, the head 120 of the coupler 100 is more clearly visible. Additionally, the socket 125 is visible.

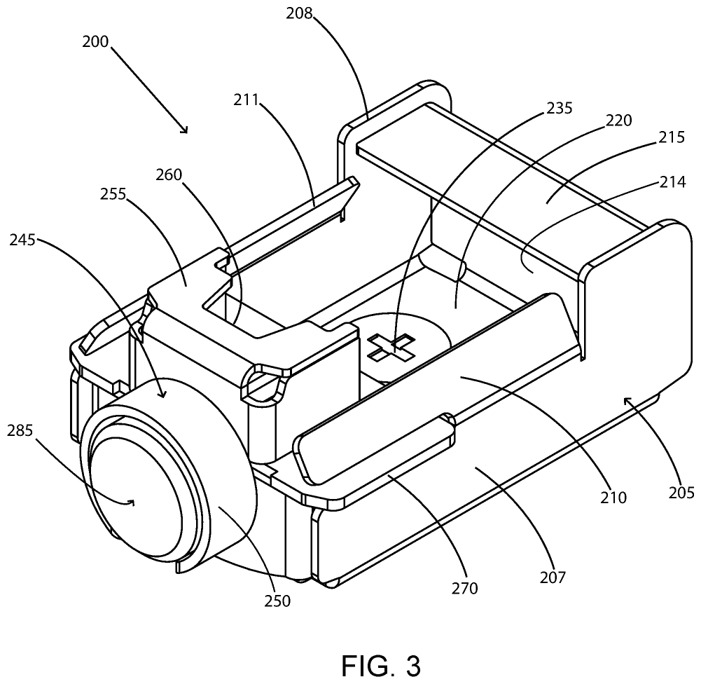

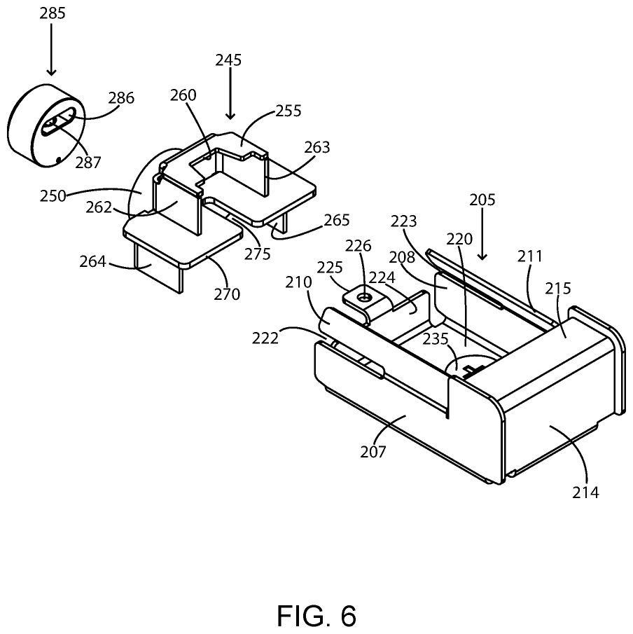

FIGS. 3-6 conceptually illustrate the exemplary lock assembly 200 apart from (without) the gooseneck coupler. A retainer plate (retainer) 270 is shown received in a slot of a lock housing 245. The lock housing 245 includes a tubular compartment 250 sized and shaped to receive a hidden shackle lock 285. The exemplary lock 285 includes a lock cylinder at the bottom of the hidden shackle lock 285, which aligns with the window 254 at the bottom of the tubular compartment 250.

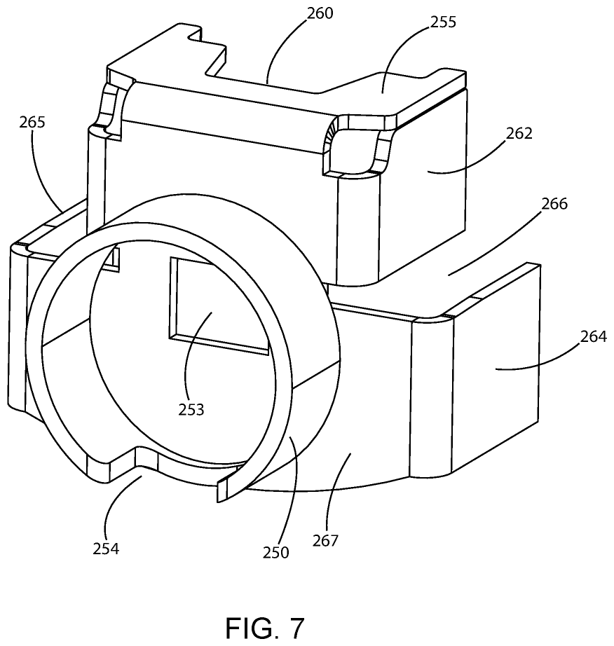

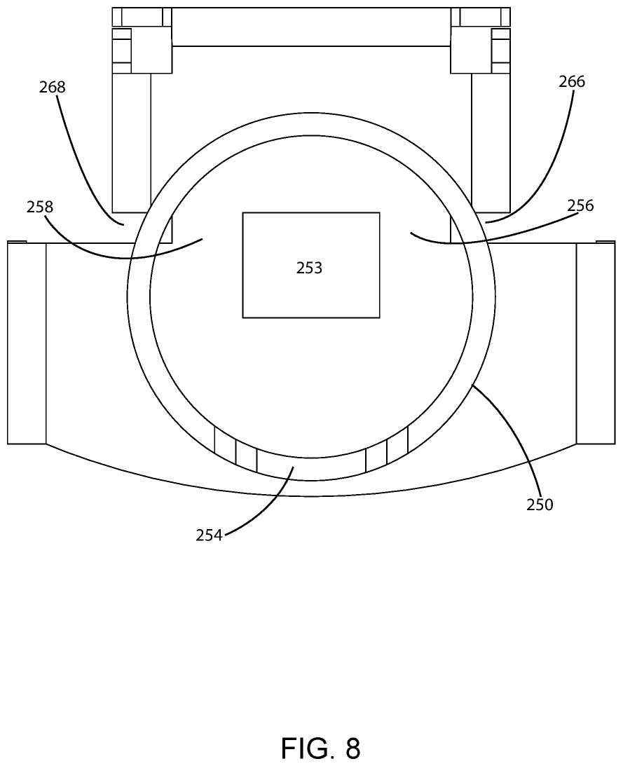

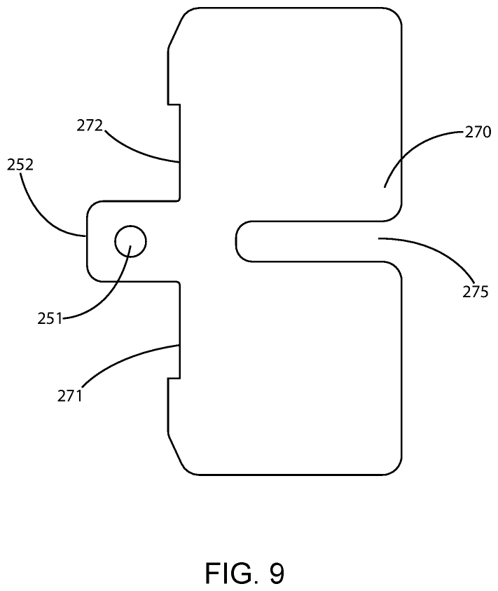

The retainer 270 includes a staple (a tab with a hole 251) 252, which extends through a window in the lock housing 245, into the tubular compartment 250. The hole 251 is shaped and sized to receive a shackle of the lock 285. The retainer 270, as more clearly shown in FIG. 9, also includes a latch retention slot 275, which is sized and shaped to receive a latch 115 of a coupler 100, and impede movement of the latch 115 from a locked position to an open (unlocked) position. Furthermore, the retainer plate includes notches 271, 272 which are sized and shaped to receive panels 256 and 258 of the lock housing 245, as shown more clearly in FIGS. 7 and 8. The panels 256 and 258 extend from each side of the window 253 to the edges of the respective slots 266, 268. The depth of the notches 271, 272, may be about equal to the thickness of the metal comprising the panels 256 and 258. The notch retention feature resists lateral movement of the installed retainer 270.

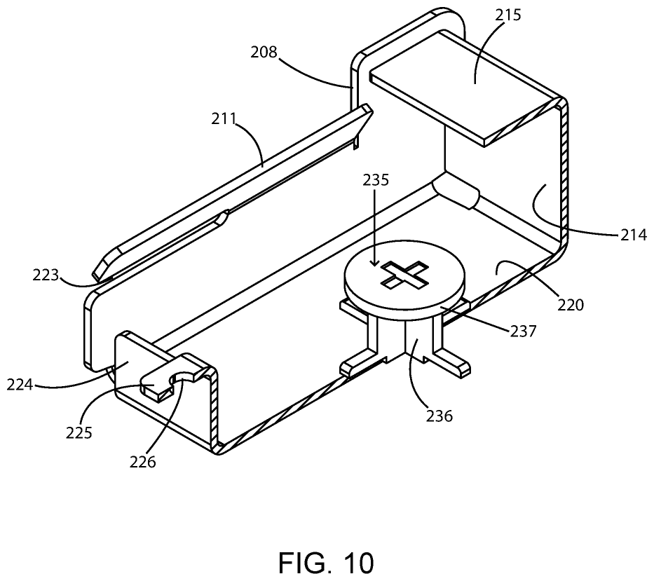

The case 205, as also shown in FIG. 10, includes a base 220 with sidewalls 207, 208 extending upwardly from the base 220. Side upper panels 210, 211 extend upwardly and inwardly (towards the base 220) from the sidewalls 207, 208. An obtuse angle is formed between a sidewall and its corresponding side upper panel, measured from the side of the sidewall that faces the base 220. The side upper panels 210, 211 cover, conceal and protect portions of an engaged head 120.

Slots 222, 223 are formed at the leading edge of the case 205, between each sidewall 207, 208 and its corresponding side upper panel 210, 211. The slots 222, 223 are sized and shaped to receive at least a substantial portion of the retainer 270. The width of each slot 222, 223 is about equal to or slightly greater than the thickness of the retainer 270. This configuration allows linear movement of the retainer 270 into and out of the slots 222, 223 while resisting appreciable pivoting (pitching and rolling) motion of the retainer 270 in the slots 222, 223. When fully installed in the slots 222, 223, the rear of the retainer abuts (or nearly abuts) the back of the slots 222, 223. This configuration resists appreciable yawing motion of the retainer 270. Thus, when installed, the retainer 270 is constrained from appreciable rotating motion about each of three orthogonal axes.

A front wall 224 extends upwardly from the front of the base 220 between the sidewalls 207, 208. A hasp 225 extends from the front wall 224, i.e., from the top edge of the front wall 224, perpendicular to the front wall 224, away from the base 220. The hasp 225 includes a hole 226 through which a shackle of a lock (e.g., a hidden shackle lock) may extend.

A rear wall 214 extends upwardly from the rear of the base 220 between the sidewalls 207, 208. A rear upper panel 215 extends perpendicularly, from the top edge of the rear wall 214, towards (overhanging) the base 220. The rear upper panel 215 covers, conceals and protects a portion of an engaged head 120. In combination, the side upper panels 210, 211 and the rear upper panel 215 cover, conceal and protect the engaged head 120 from three sides (e.g., left, right and back). As discussed below, the lock housing 245 protects the front of the engaged head and performs other important functions.

A ball profile 235 extends upwardly from the base 220 of the case 205. The ball profile 235 is an optional but beneficial component. The ball profile 235 includes a disc-shaped component (disc) 237 with an outer diameter equal to (or about equal to) the diameter of a towing ball. The ball profile 235 also includes a pedestal 236. The pedestal 236 elevates the disc 237 a determined distance above the base 220 of the case 205. The determined distance is equal to (or about equal to) the length of a neck of a tow ball. The maximum width of the pedestal 236 is about equal to or less than the maximum width or diameter of a neck of a tow ball.

When the ball profile 235 is inserted into a socket 125 of a gooseneck coupler 100, the pedestal 236 positions the disc 237 above a locking mechanism in the socket 125. When the lever 115 of the gooseneck coupler 100 is in a locked position and the ball profile 235 is fully inserted in the socket 125, the locking mechanism in the socket 125 prevents withdrawal of the disc 237 from the socket 125 by impeding its passage. A linkage couples the locking mechanism to the lever 115. The locking mechanism may be a pin, cylinder, block, anvil or other structure that moves from a position that does not impede passage of the disc 237 from the socket 125 when the lever 115 is in an unlocked position, to a position that does impede passage of the disc 237 from the socket 125 when the lever is in a locked position.

Structures other than the ball profile 235 may be used without departing from the scope of the invention. By way of example and not limitation, a mushroom shaped structure may be used, with the head of the mushroom shape having a width about equal to the diameter of a tow ball, and the neck of the mushroom having a width about equal to the diameter or width of a neck of a tow ball, and the neck also having a length about equal to the length of a neck of a tow ball. An actual tow ball may be used as a ball profile 235. A structure having any shape that is engageable and lockable in a socket 125 of a gooseneck coupler and removable when the gooseneck coupler is unlocked may be used as a ball profile 235.

FIGS. 7 and 8 conceptually illustrate an exemplary lock housing 245 for an exemplary gooseneck coupler lock assembly 200 according to principles of the invention. The lock housing 245 receives the front of a gooseneck coupler head 120. The lock housing 245 includes a front panel 267, bottom side panels 264, 265, and top side panels 262, 263. Opposite side panels are parallel and aligned. Thus panel 264 is opposite to, aligned and parallel with panel 265. Panel 262 is opposite to, aligned and parallel with panel 263.

The distance between bottom panels 264, 265 is greater than the distance between top side panels 262, 263. The distance between bottom panels 264, 265 is slightly less than the distance between sidewalls 207, 208. When assembled, bottom panels 264, 265 slide into gaps between sidewalls 207, 208 and front wall 224 of the base. 205, with the bottom panels 264, 265 being immediately adjacent to or abutting sidewalls 207, 208, and resting upon the base 220.

Gaps 266, 268 separate the top side panels 262, 263 from the bottom side panels 264, 265. The gaps 266, 268 define a slot for receiving a substantial portion of the retainer 270, while the retainer is also received in slots 222, 223 formed at the leading edge of the case 205, between each sidewall 207, 208 and its corresponding side upper panel 210, 211. When fully installed in the gaps 266, 268, the front of the retainer 270 abuts (or nearly abuts) the front panel 267.

The retainer 270 (FIG. 9) also includes a staple (a tab with a hole 251) 252, which extends through a window 253 in the front panel 267 of the lock housing 245, into the tubular compartment 250, when the retainer 270 is fully installed in the gaps 266, 268. A hasp 225 (i.e., another staple with a hole) extends from the front wall 224 of the case 205, i.e., from the top edge of the front wall 224, perpendicular to the front wall 224, away from the base 220. The hasp 225 includes a hole 226. The staple 252 and hasp 225 both extend through the window 253, when the lock 200 is assembled. The holes 251 and 226 align when the lock 200 is assembled. A shackle 287 of a lock (e.g., a hidden shackle lock) 285 may extend through the holes 251 and 226 when the lock 200 is assembled. The staple 252 and hasp 225 extend into the shackle compartment 286 of the hidden shackle lock 285 (aka puck lock). In such configuration, the staple 252 and hasp 225 cannot be withdrawn from the window 253. In such configuration, the case 205, housing 245 and retainer 270 are locked together in an assembly and cannot be separated without substantial structural compromise.

The retainer 270 also includes spaced apart recessed portions 271, 272 along the leading (front) edge thereof. The recessed portions 271, 272 are sized and positioned to matingly receive portions 256, 258 of the front panel 267, on each side of the window 253. The depth of the recessed portions 271, 272 about equals the thickness of the received portions 256, 258 of the front panel 267. When the retainer 270 is fully installed in the gaps 266, 268, the recessed portions 271, 272 receive, engage and mate with the portions 256, 258 of the front panel 267, on each side of the window 253. This mating engagement resists side to side movement of the retainer 270. This configuration also resists appreciable yawing motion of the retainer 270. When installed, the retainer 270 is constrained from appreciable rotating motion about each of three orthogonal axes.

The retainer 270 also includes a lever slot 275. The lever slot 275 is sized and shaped to receive a portion of the lever 115 in the locked position when the lock assembly 200 is installed on the head 120 of a gooseneck coupler 100. The slot 275 constrains the received portion of the lever 115 from pivoting to an open position from a locked position.

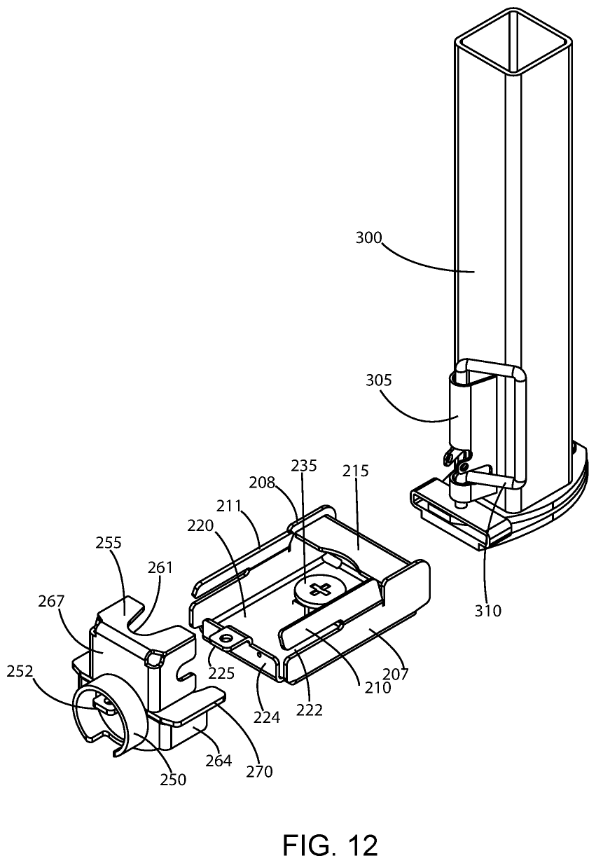

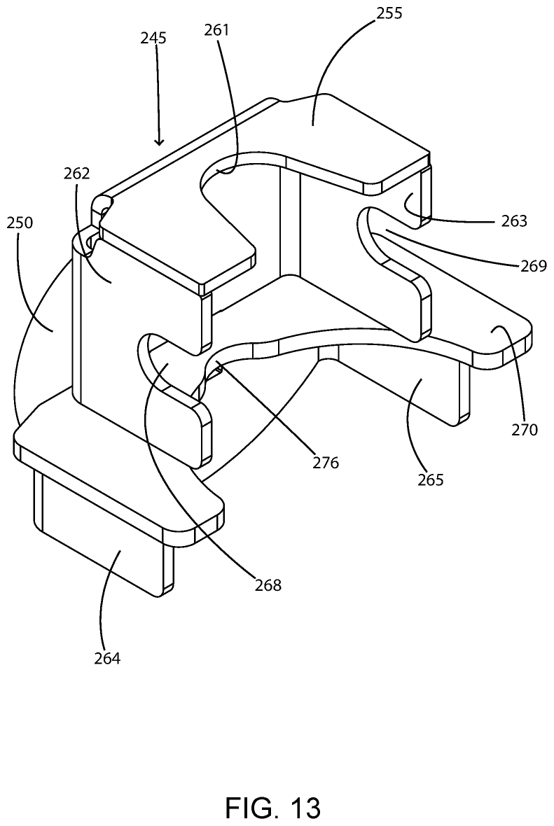

The slot 275 can be shaped and sized to accommodate a wide variety of levers 115. By way of example and not limitation, a broad concave slot 276 (FIG. 13) may be provided to engage a lever assembly 305 (FIG. 12) with a lever (handle) 310 that pivots about a vertical axis parallel to the longitudinal axis of the gooseneck 300. In this configuration, the slot 276 does not constrain the received portion of the lever 310 from pivoting to an open position from a locked position. Rather, the slot 276 allows the housing to be properly positioned for assembly and utility.

The retainer plate 270 may be configured, selected, and replaced to accommodate a wide range of levers and lever actions. The retainer is a removable and replaceable component, one that may be selected and configured for a particular lever or a range of levers, and one that may be replaced to work with a different lever or a different range of levers.

The lock housing 245 includes a tubular compartment 250 sized and shaped to receive a hidden shackle lock 285. The tubular compartment 250 is tubular flange that extends from the front panel 267 Of the housing 245. The inner diameter of the tubular compartment 250 is slightly greater than the outer diameter of the hidden shackle lock 285. The distance by which the tubular compartment 250 extends from the front panel 267 is at least about equal to the thickness of the hidden shackle lock 285. The tubular compartment 250 defines a volume that is sized and shaped to receive the hidden shackle padlock 285, the staple 252 and hasp 225. A notch 254 is formed at the bottom of the tubular compartment 250. The notch 254 provides access to a lock cylinder in the periphery of the hidden shackle lock 285.

An upper panel 255 extends perpendicularly, from the top edge of the front panel 267, from the side of the front panel 267 opposite the tubular compartment 250. When the lock assembly 200 is assembled, the upper panel 255 extends towards (overhangs) the base 220, covering, concealing and protecting a portion of an engaged head 120. In combination, the side upper panels 210, 211, the rear upper panel 215 and the upper panel 255 of the housing 245 cover, conceal and protect the engaged head 120 from four sides (e.g., left, right, front and back).

A recess 260 is formed in the upper panel 255. The recess 260 receives a portion of the lever 115, 305 assembly. This allows the upper panel 255 of the housing 245 to substantially cover the front of the engaged head 120.

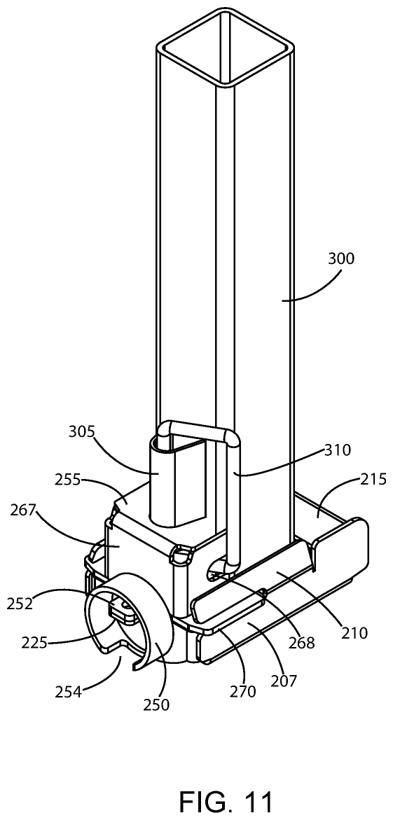

The gooseneck coupler 300 of FIGS. 11 and 12 features a different latch mechanism 305 than the latch mechanism 115 of the gooseneck coupler of FIG. 1. The latch mechanism 305 includes a lever or handle 310 that pivots about an axis that is generally parallel to the longitudinal axis of the neck of the gooseneck coupler 300. FIG. 12 shows the handle 310 in a locked position. Movement of the handle 310 from the locked position is prevented by a notch 268 in the lock housing 245 (FIG. 13). A pair of notches 268 and 269 are provided one opposite sides of top side panels 262, 263. The notches are aligned. This configuration allows the handle 310 to be restrained in the locked position, whether the locked position corresponds to one side or the other side. As there is no standard in the industry, this configuration provides flexibility.

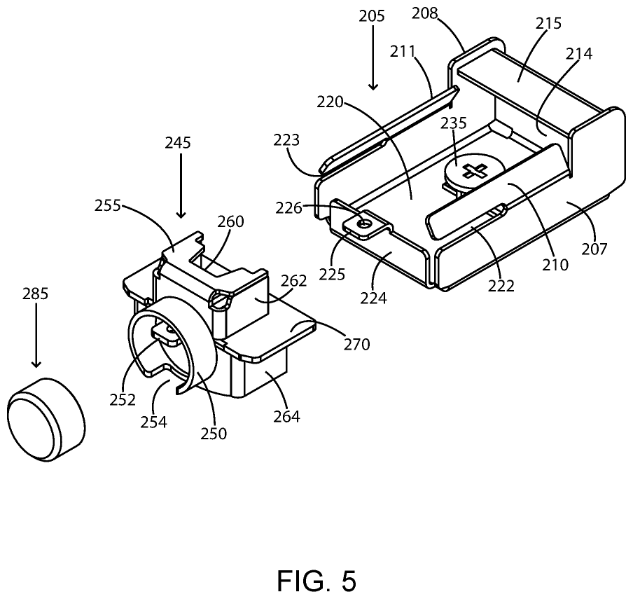

Optionally, the notches 268, 269 can be incorporated into the housing 245 of FIGS. 5-8. While the notches 268, 269 are not required for the latch mechanism 115 of FIGS. 1 and 2, they do not compromise utility of the housing 245. Thus, the notches 268, 269 may be included to provide a user the flexibility of using the lock assembly with different gooseneck couplers.

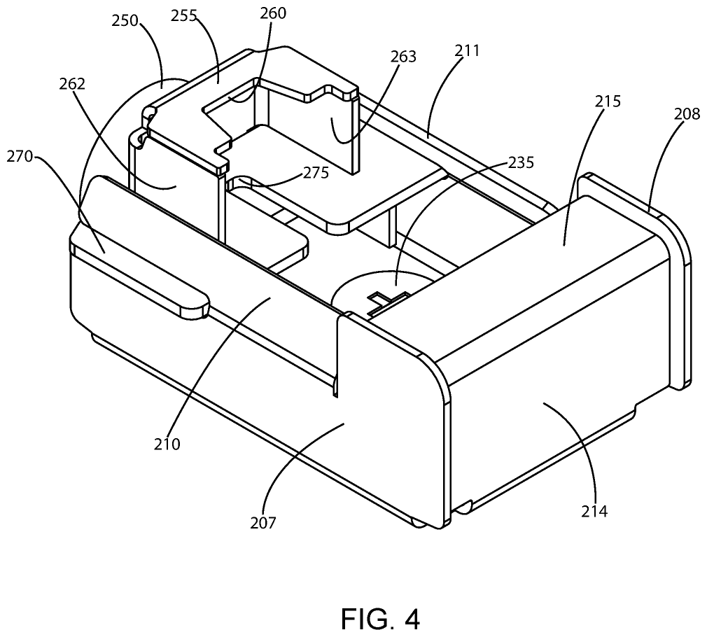

Another difference between the lock assembly of FIGS. 3 and 4 and the lock assembly of FIGS. 11-13 is the retainer plate 270. Specifically, the narrow slot 275, which is shaped and sized to accommodate a lever 115, is replaced with a broad concave slot 276 (FIG. 13). The broad concave slot receives the latch mechanism cover 305. In this configuration, the slot 276 does not constrain any received portion of the lever 310 from pivoting to an open position from a locked position. Rather, the slot 276 allows the housing to be properly positioned for assembly and utility, while a notch 268, 269 constrain the handle 310 from pivoting to an open position from a locked position.

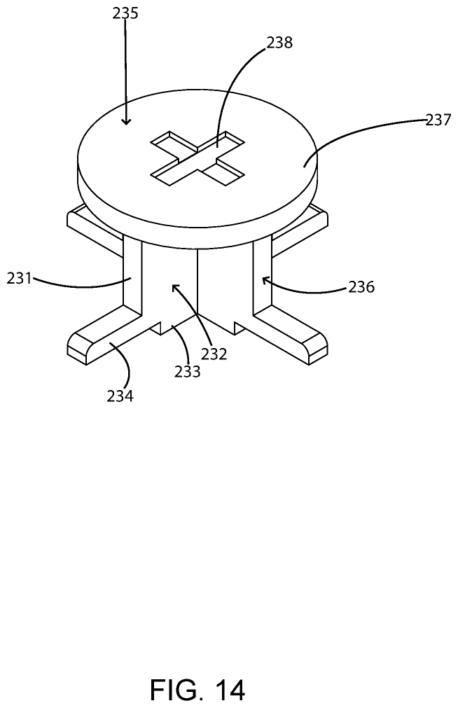

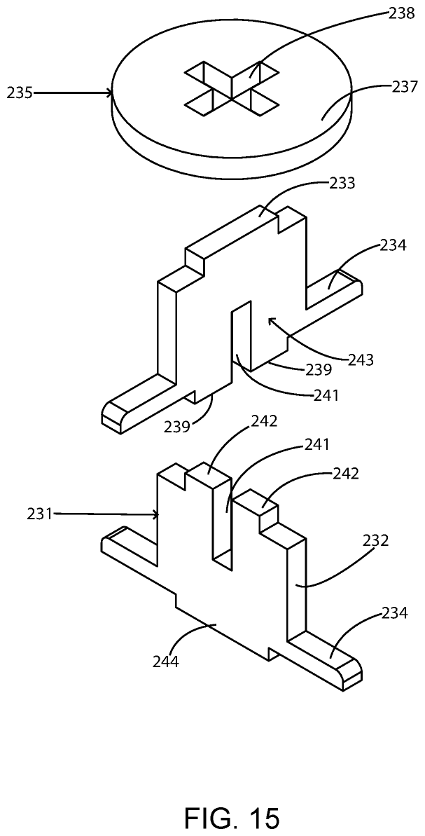

FIGS. 14-16 conceptually illustrate an exemplary ball profile 235 for an exemplary gooseneck coupler lock assembly according to principles of the invention. The ball profile 235 includes a disc-shaped component (disc) 237 with an outer diameter equal to (or about equal to) the diameter of a towing ball. The disc 237 includes a central cross-shaped slot 238 sized and shaped to receive tabs 239 (e.g., two tabs of separated by slot 241) and tab 233 of the legs 231, 243 of the pedestal 236. The base 220 also includes a cross-shaped slot. The pedestal 236 elevates the disc 237 a determined distance above the base 220 of the case 205. The disc 237 lies in a plane that is generally parallel to the plane in which the base 220 of the case 205 lies, and perpendicular to the longitudinal axis of the pedestal 236.

The pedestal 236 is an assembly comprised of a pair of similar slotted and tabbed legs 231, 243. The legs 231, 243 fit together to form the pedestal 236 by aligning and sliding slots 241 toward each other and continuing the sliding until tabs 239 and 244 are aligned with their outermost surfaces in the same plane, and tabs 233 and 242 are aligned with their outermost surfaces in the same plane. The positions of the feet 234 differ between the legs 231, 243. The feet 234 are positioned near tab 244 on one leg 231, and near tabs 239 on the other leg 243. The assembled pedestal 236 is oriented with the feet 234 against the base 220 of the case 205.

In another embodiment, each leg 231, 243 may be identical. In such an embodiment, each leg 231, 243 may include feet near tabs 239 and 244, and near tabs 233 and 242. In such an embodiment, the pedestal 236 may have feet abutting the underside of the disc 237 and feet abutting the base 220 of the case 205.

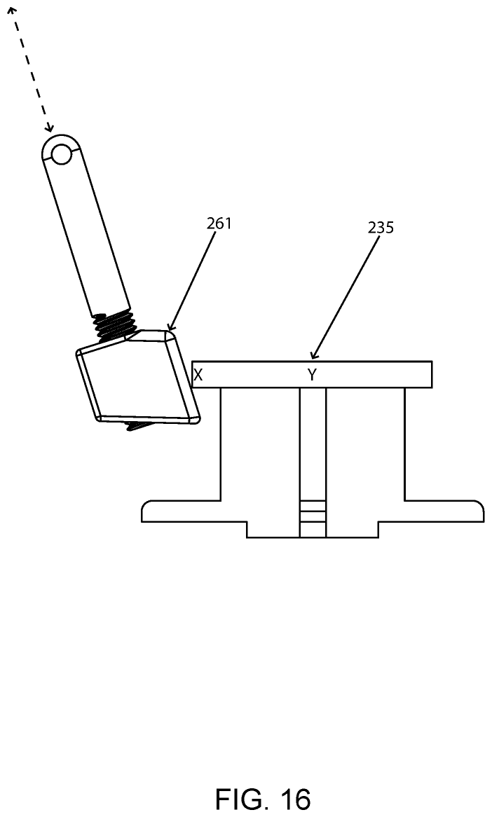

FIG. 16 is a side view of an exemplary ball profile engaged by an underjaw 261 of an exemplary gooseneck coupler according to principles of the invention. A connecting rod couples a latch handle or lever to an underjaw 261. The underjaw 261 is a polyhedron with a face configured to abut a portion of a trailer hitch ball. It may be solid or hollow, e.g., formed of sheet metal. The underjaw 261 is positioned against at least a portion of the bottom half of a trailer hitch ball (or a ball profile 235) when the underjaw 261 is in a locked position. In the locked position, the underjaw 261 prevents withdrawal of an engaged trailer hitch ball (or a ball profile 235) from the socket 125. The underjaw 261 is withdrawn away from the trailer hitch ball (or a ball profile 235) when the underjaw 261 is moved to an unlocked position. The motion of the underjaw 261 is caused by reciprocating motion of a connecting rod. Pivoting motion of a latch handle causes reciprocating motion of the connecting rod. The latch handle is restrained from such pivoting motion by the latch retention slot 275 or by one of the notches 268, 269 in the lock housing 245.

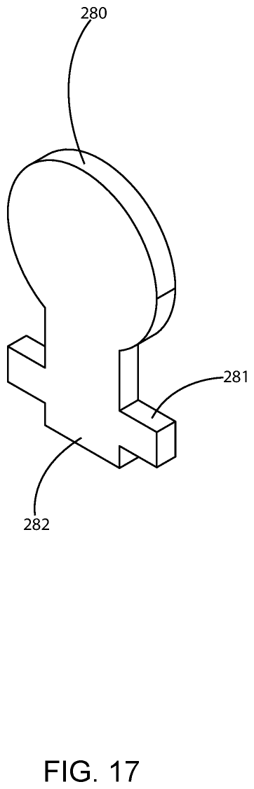

Other underjaw 261 configurations, linkages and movements may be utilized without departing from the scope of the invention. Regardless, in any configuration, when the underjaw 261 is in a locked position, it abuts one portion (portion X) of the surface of the ball or ball profile 235. The underjaw 261 does not interact with other portions, such as portion Y, that are away from the abutted portion (portion X). Thus, if a planar sheet ball profile 280 as shown in FIG. 17 is used, the underjaw 261 will abut on a portion of an edge of the ball profile 280. Rotation or lateral movement of the ball profile 280 relative to the underjaw 261 could cause the ball profile 280 to disengage from the underjaw 261. To reduce risk of rotation and lateral movement, the ball profile 280 is equipped with feet 281 and a tab 282. The feet 281 abut the base 220 of the case 205, while the tab 282 is received in a slot of the base 220.

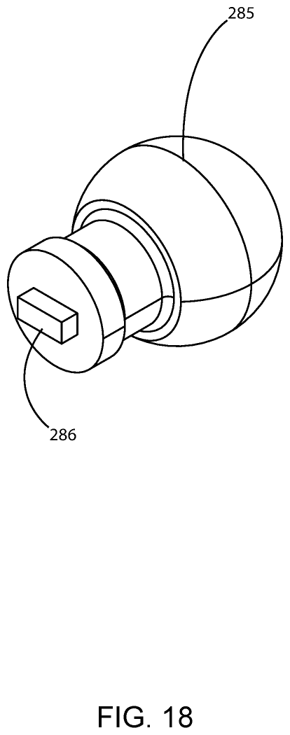

Another ball profile 285, a full trailer ball, is illustrated in FIG. 18. The ball profile 285 is equipped with a tab 286. The tab 286 is received in a slot of the base 220. Such a ball profile 285 may be used within the scope of the invention.

In sum, a lock assembly according to principles of the invention, in assembled form, provides a protected volume in which the head of a coupler (e.g., a gooseneck coupler) is contained. The lock assembly may include a ball profile, that is received and locked in the socket of the gooseneck coupler by impeding movement of the latch assembly of the gooseneck coupler from a locked position to an unlocked position. The assembly is secured together with a shackle of a hidden shackle lock. The hidden shackle lock resides in a protective tubular flange compartment of a portion of the lock assembly. Other components of the lock assembly include a tab with hole through which the shackle extends to lock the components together.

A lock assembly 200 according to principles of the invention may be comprised of metal (e.g., cold rolled steel) sheet that is cut and bent into shape for the lock housing, a retainer plate and a coupler head case. The tubular flange 250 for receiving a hidden shackle lock 285 may be comprised of a portion of a tube (e.g., round steel tube) that is cut to size, notched and attached (e.g., welded) to the front panel 267 of the lock housing 245. The retainer plate 270 is planar and does not require any bending. However, the invention is not limited to a particular method of manufacture. Other methods of manufacture, including but not limited to, machining and metal casting may be used to create components of the lock assembly 200 according to principles of the invention. Likewise the invention is not limited to particular materials. Any material that is suitable for a theft deterrent device and may be formed into a lock housing, a retainer plate and a coupler head case, as described herein, may be utilized without departing from the scope of the invention. By way of example, and not limitation, steel that has been heat-treated to increase its hardness, such as tool steel or hardened alloys, wear resistant steel (e.g., Hardox® by SSAB Technology AB a Swedish Corp.), and abrasion resistant steel with a high hardness rating achieved through alloying elements and heat treatment processes, may be utilized within the spirit and scope of the invention.

Any dimensions and sizes are provided as approximate dimensions for an embodiment. Dimensions and sizes may be varied without departing from the scope of the invention. Varied dimensions and sizes that do not substantially impair utility of the invention come within the spirit and scope of the invention. Subject to the foregoing, unless otherwise specified herein, any claimed dimensions or size may be varied by at least ±5% without departing from the scope of the invention; and about equal, approximately equal or similar phrasing means equal to or within ±5% of equality.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A gooseneck coupler lock assembly comprising:
a base, the base having 4 sides and a first wall extending upward from the base along a first side, a second wall extending upward from the base along a second side, a third wall extending upward from the base along a third side, and each wall including a top, and an upper base panel extending from the top of each of the first, second and third walls, and each upper base panel overhanging the base;
a front panel coupled to the base and including a top, and an upper front panel extending from the top of the front panel, and the upper front panel overhanging the base at the fourth side of the base;
a lock securing the base to the front panel;
a ball profile extending from the base;
wherein the base, first, second and third walls, and the front panel define a volume for receiving a head of a gooseneck coupler, and the upper base panels and upper front panel define an obstruction that prevents removal of the gooseneck coupler from the volume.

2. The gooseneck coupler lock assembly according to claim 1, further comprising a fourth wall along the fourth side of the base, and a first tab extending outwardly from and perpendicular to the fourth wall, the first tab extending away from the base, and the first tab including a first hole for receiving a shackle.

3. The gooseneck coupler lock assembly according to claim 2, further comprising a first bottom side panel, a second bottom side panel, a first top side panel, and a second top side panel extending from the front panel, the first bottom side panel being disposed against the first wall and the base, and the second bottom side panel being disposed against the second wall and the base.

4. The gooseneck coupler lock assembly according to claim 3, further comprising a window formed in the front panel, and the first tab extending through the window.

5. The gooseneck coupler lock assembly according to claim 4, further comprising a tubular flange extending from the front panel and circumscribing the window.

6. The gooseneck coupler lock assembly according to claim 5, further comprising a first slot between the first bottom side panel and the first top side panel, and a second slot between the second bottom side panel and the second top side panel.

7. The gooseneck coupler lock assembly according to claim 6, further comprising a third slot between the first wall and the upper base panel extending from the first wall, a fourth slot between the second wall and the upper base panel extending from the second wall.

8. The gooseneck coupler lock assembly according to claim 7, further comprising a retainer plate disposed in the first slot, second slot, third slot and fourth slot, the retainer plate including a second tab, the second tab including a second hole for receiving a shackle, and the second tab extending through the window.

9. The gooseneck coupler lock assembly according to claim 8, wherein the second tab is aligned with and parallel to the first tab, and the second hole is aligned with the first hole.

10. The gooseneck coupler lock assembly according to claim 9, the retainer plate including a groove configured to receive a gooseneck coupler lever.

11. The gooseneck coupler lock assembly according to claim 9, the retainer plate including a concave recess configured to receive a gooseneck coupler latch housing.

12. The gooseneck coupler lock assembly according to claim 9, further comprising a latch handle retention notch in at least one of the first top side panel and the second top side panel, the latch handle retention notch configured to receive and retain a portion of a gooseneck coupler latch handle in a locked position.

13. The gooseneck coupler lock assembly according to claim 9, further comprising a gooseneck coupler socket ball profile extending upward from the base.

14. The gooseneck coupler lock assembly according to claim 9, the lock comprising a padlock with a shackle extending through the first hole and second hole.

15. The gooseneck coupler lock assembly according to claim 10, wherein the padlock is a hidden shackle padlock disposed within the tubular flange.

16. A trailer coupler lock assembly comprising:
a case defining a volume for receiving a head of a trailer coupler, the case including a first tab with a first hole for receiving a shackle;
a ball profile coupled to the case, the ball profile including a disc and a pedestal, the pedestal extending vertically and supporting the disc, and the disc being horizontal, the disc being sized for engagement by the trailer coupler; and
a lock housing coupled to the base, the lock housing including a window through which the first tab extends.

17. The trailer coupler lock assembly according to claim 16, wherein the case includes a base, the base having 4 sides and a first wall extending upward from the base along a first side, a second wall extending upward from the base along a second side, a third wall extending upward from the base along a third side, and each wall including a top, and an upper base panel extending from the top of each of the first, second and third walls, and each upper base panel overhanging the base, a fourth wall along the fourth side of the base, and the first tab extending outwardly from and perpendicular to the fourth wall, the first tab extending away from the base; and
the lock housing includes a front panel with a top, and an upper front panel extending from the top of the front panel, and the upper front panel overhanging the base at the fourth side of the base when the lock housing is coupled to the base, and the window being formed in the front panel, and a tubular flange extending from the front panel and circumscribing the window.

18. The trailer coupler lock assembly according to claim 17, further comprising a first bottom side panel, a second bottom side panel, a first top side panel, and a second top side panel extending from the front panel, the first bottom side panel being disposed against the first wall and the base, and the second bottom side panel being disposed against the second wall and the base.

19. The trailer coupler lock assembly according to claim 18, further comprising a first slot between the first bottom side panel and the first top side panel, and a second slot between the second bottom side panel and the second top side panel, a third slot between the first wall and the upper base panel extending from the first wall, a fourth slot between the second wall and the upper base panel extending from the second wall, and a retainer plate disposed in the first slot, second slot, third slot and fourth slot, the retainer plate including a second tab, the second tab including a second hole for receiving a shackle, and the second tab extending through the window, and the second tab being aligned with and parallel to the first tab, and the second hole being aligned with the first hole.

20. The trailer coupler lock assembly according to claim 19, the retainer plate including one of a groove configured to receive a gooseneck coupler lever and a concave recess configured to receive a gooseneck coupler latch housing.
